(19) United States
(12) Patent Application Publication
(10) Pub. No.: US 2023/0254768 A1
(43) Pub. Date: Aug. 10, 2023

(54) POWER MANAGEMENT OF RECEIVER CHAIN CIRCUITS BASED ON TRAFFIC AWARENESS

(71) Applicant: Meta Platforms Technologies, LLC, Menlo Park, CA (US)

(72) Inventors: Ping Wang, Redmond, WA (US); Swaminathan Balakrishnan, Los Gatos, CA (US); Pritesh Vora, San Diego, CA (US); Jibu Joseph, Santa Clara, CA (US); Achaleshwar Sahai, San Jose, CA (US)

(21) Appl. No.: 18/087,067

(22) Filed: Dec. 22, 2022

Related U.S. Application Data
(60) Provisional application No. 63/308,765, filed on Feb. 10, 2022.

(51) Int. Cl. H04W 52/02; H04W 76/28

(52) U.S. Cl. CPC H04W 52/0225; H04W 76/28

(57) ABSTRACT

Disclosed herein is an approach for improving energy efficiency of a wireless communication device by reducing power distributed to receiver chain circuits (RCCs) based on determining whether the incoming wireless data is to be received and processed by the RCCs within an upcoming time duration. A device can identify a plurality of RCCs for processing data to be received by the device from a network. The device can determine that a first RCC of the plurality of RCCs is to receive the data within a time duration and that a second RCC of the plurality of RCCs is to receive no data within the time duration. The device can cause, responsive to the determination, power to be reduced to the second RCC and not be reduced to the first RCC, within the time duration.

### CROSS-REFERENCE TO RELATED APPLICATIONS

This application claims priority to U.S. Provisional Application Ser. No. 63/308,765 filed Feb. 10, 2022, which is incorporated by reference in its entirety for all purposes.

### BACKGROUND

Artificial reality such as a virtual reality (VR), an augmented reality (AR), or a mixed reality (MR) provides immersive experience to a user. In one example, a user using a user equipment (UE) device, such as a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space). An image of a virtual object may be generated by a console communicatively coupled to the HWD. In some embodiments, the console may have access to a network.

### SUMMARY

When an application executing on a UE device receives wireless data from a network, the wireless data can be received in periodic bursts. For example, receiver chain circuits (e.g., component of a receiver chain) of a UE for processing incoming data can receive bursts of data within specific portions of periodic time intervals, while no data may be received outside of the specific portions of the time intervals. However, as receiver chain circuits consume power even during periods where they do not receive and process data, their idle operation draws battery power and reduces the energy efficiency of the UE device. The present solution improves the energy efficiency of UE devices by predicting/deciding/determining specific time periods during which the data is expected to be received by at least some receiver chain circuits, as well as the time periods during which the data is not expected to be received. The present solution can use this determination to power down at least some of the receiver chain circuits not expected to receive wireless data during time periods in which the data is not expected to be received, while keeping powered up those receiver chain circuits that are expected to receive data. Using this technique, the present solution can improve the energy efficiency of the UE device, while maintaining timely processing of the received incoming data.

In some aspects, the present solution relates to a method. The method can include identifying, by a wireless communication device, a plurality of receiver chain circuits for processing data to be received by the wireless communication device from a wireless network. The method can include determining, by the wireless communication device, that a first receiver chain circuit of the plurality of receiver chain circuits is to receive the data within a time duration. The wireless communication device can determine that a second receiver chain circuit of the plurality of receiver chain circuits is to receive no data within the time duration. The method can include causing, by the wireless communication device responsive to the determination, power to be reduced to the second receiver chain circuit and not be reduced to the first receiver chain circuit, within the first time duration.

The time duration can be within an off period of a discontinuous reception (DRX) cycle of the plurality of receiver chain circuits of the wireless communication device. The method can include causing, by the wireless communication device, the power to not be reduced to the first receiver chain circuit and the second receiver chain circuit within an on period of a discontinuous reception (DRX) cycle.

The method can include determining, by the wireless communication device, that the first receiver chain circuit and the second receiver chain circuit are each to have at least a defined likelihood (e.g., a likelihood above a defined threshold) of receiving the data within another time duration during an off period of a discontinuous reception (DRX) cycle. Responsive to the determination that the first receiver chain circuit and the second receiver chain circuit are each to have at least a defined likelihood of receiving the data within the another time duration, the wireless communication device can cause the power to not be reduced to the first receiver chain circuit and the second receiver chain circuit within the another time duration.

The method can include determining, by the wireless communication device, that the first receiver chain circuit and the second receiver chain circuit are each to have at least a defined likelihood of receiving the data within the time duration. The wireless communication device can determine that by determining that a first application or function associated with the first receiver chain circuit is expected to receive the data within the time duration, and that a second application or function associated with the second receiver chain circuit is expected to receive no data within the time duration.

Each of the plurality of receiver chain circuits can include at least one of: a multiplexer, a filter, a mixer, an amplifier, or an analog to digital converter. The method can include causing, by the wireless communication device, the power to be reduced to the second receiver chain circuit by causing at least one of a multiplexer, a filter, a mixer, an amplifier or an analog to digital converter of the second receiver chain circuit to be disconnected or gated from the power.

The method can include determining, by the wireless communication device, that a third receiver chain circuit of the plurality of receiver chain circuits is to receive no data within the time duration. The wireless communication device can cause, responsive to the determination that the third receiver chain circuit is to receive no data within the time duration, power to be reduced to the third receiver chain circuit within the first time duration. The first time instance can be within an off period of a discontinuous reception (DRX) cycle.

The method can include determining, by the wireless communication device, that an application associated with the first receiver chain circuit received prior data within a portion of a preceding time interval that corresponds to the time duration. The method can include predicting, by the wireless communication device, responsive to the application receiving the prior data within the portion, that the first receiver chain circuit is to receive the data within the time instance.

The method can include determining, by the wireless communication device, that an application associated with the second receiver chain circuit did not receive prior data within a portion of a preceding time interval that corresponds to the time duration. The method can include predicting, by the wireless communication device responsive to the application not receiving the prior data within the portion, that the second receiver chain circuit is to receive no data within the time instance.

In some aspects, the present solution relates to a wireless communication device. The wireless communication device can include one or more processors configured to identify a plurality of receiver chain circuits for processing data to be received by the wireless communication device from a wireless network. The one or more processors can be configured to determine that a first receiver chain circuit of the plurality of receiver chain circuits is to receive the data within a time duration and that a second receiver chain circuit of the plurality of receiver chain circuits is to receive no data within the time duration. Responsive to the determination, the one or more processors can cause power to be reduced to the second receiver chain circuit and not be reduced to the first receiver chain circuit, within the first time duration.

The time duration can be within an off period of a discontinuous reception (DRX) cycle of the plurality of receiver chain circuits of the wireless communication device. The one or more processors can be configured to cause the power to not be reduced to the first receiver chain circuit and the second receiver chain circuit within an on period of a discontinuous reception (DRX) cycle. The one or more processors can be configured to determine that the first receiver chain circuit and the second receiver chain circuit are each to have at least a defined likelihood (e.g. a likelihood above a defined threshold) of receiving the data within another time duration during an off period of a discontinuous reception (DRX) cycle. Responsive to the determination that the first receiver chain circuit and the second receiver chain circuit are each to have the at least a defined likelihood above a defined threshold of receiving the data within the another time duration, the one or more processors can cause the power to not be reduced to the first receiver chain circuit and the second receiver chain circuit within the another time duration.

The one or more processors can be configured to determine that the first receiver chain circuit and the second receiver chain circuit are each to have at least a defined likelihood of receiving the data within the time duration and that the second receiver chain circuit is to receive no data within the time duration. The one or more processors can make this determination by determining that a first application or function associated with the first receiver chain circuit is expected to receive the data within the time duration, and that a second application or function associated with the second receiver chain circuit is expected to receive no data within the time duration.

Each of the plurality of receiver chain circuits can include at least one of: a multiplexer, a filter, a mixer, an amplifier, or an analog to digital converter. The one or more processors can be configured to cause the power to be reduced to the second receiver chain circuit by causing at least one of a multiplexer, a filter, a mixer, an amplifier or an analog to digital converter of the second receiver chain circuit to be disconnected or gated from the power.

The one or more processors can be configured to determine that a third receiver chain circuit of the plurality of receiver chain circuits is to receive no data within the time duration. Responsive to the determination that the third receiver chain circuit is to receive no data within the time duration, the one or more processors can cause power to be reduced to the third receiver chain circuit within the first time duration, the first time instance within an off period of a discontinuous reception (DRX) cycle.

The one or more processors can be configured to determine that an application associated with the first receiver chain circuit received prior data within a portion of a preceding time interval that corresponds to the time duration. The one or more processors can predict, responsive to the application receiving the prior data within the portion, that the first receiver chain circuit is to receive the data within the time instance. The one or more processors can determine that an application associated with the second receiver chain circuit did not receive prior data within a portion of a preceding time interval that corresponds to the time duration. The one or more processors can predict, responsive to the application not receiving the prior data within the portion, that the second receiver chain circuit is to receive no data within the time instance.

In some aspects the present solution relates to a non-transitory computer readable medium storing program instructions. The instructions can be for causing at least one processor of a wireless communication device to identify a plurality of receiver chain circuits for processing data to be received by the wireless communication device from a wireless network. The instructions can be for causing at least one processor to determine that a first receiver chain circuit of the plurality of receiver chain circuits is to receive the data within a time duration and that a second receiver chain circuit of the plurality of receiver chain circuits is to receive no data within the time duration. The instructions can be for causing the at least one processor to, responsive to the determination, cause power to be reduced to the second receiver chain circuit and not be reduced to the first receiver chain circuit, within the first time duration. The time duration can be within an off period of a discontinuous reception (DRX) cycle of the plurality of receiver chain circuits of the wireless communication device. The instructions can be for causing at least one processor to cause the power to not be reduced to the first receiver chain circuit and the second receiver chain circuit within an on period of the DRX cycle.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a block diagram of a system for managing power consumption of receiver chain circuits based on awareness of incoming wireless data, according to an example implementation of the present disclosure.

FIG. 5 is a plot of a time interval with power levels of the receiver chain circuits across various time durations, according to an example implementation of the present disclosure.

FIG. 6 is a flow diagram of a process for managing power to receiver chain circuits based on awareness of incoming wireless data, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Applications executing on a user equipment (UE) device (e.g., an AR/VR device, head wearable device or a smartphone) can receive wireless data that can be arriving at the UE in accordance with periodic time intervals. For example, a UE device can receive data within particular portions (e.g., time periods) of periodic time intervals. In such instances, one or more receiver chain circuits of a UE device can receive and process the wireless data that is being received in periodic time intervals. However, as receiver chain circuits consume power from the battery or power supply of the UE even when the data is not being received and processed by the UE device, this idle processing can adversely affect the battery life and the energy efficiency of the UE device.

The present solution addresses these issues by determining (e.g., predicting, deciding) specific time durations within periodic time intervals when the incoming wireless data is expected to (e.g., has at least a certain likelihood to) arrive at the receiver chain circuits. The present solution can identify which receiver chain circuits are expected to receive and process the incoming wireless data that is expected to arrive within such specific time durations and which receiver chain circuits are not expected to be used during the same time durations. The present solution can reduce the power provided to at least a portion of the receiver chain circuits during the time durations for which such inactive receiver chain circuits are expected to not receive data. Likewise, the present solution can maintain unchanged (e.g., active state or full) power to the specific receiver chain circuits when such receiver chain circuits are expected to receive the data during the specific time periods. Using this technique, the present solution can improve the energy efficiency of the UE devices, while allowing for timely and effective processing of any received incoming data.

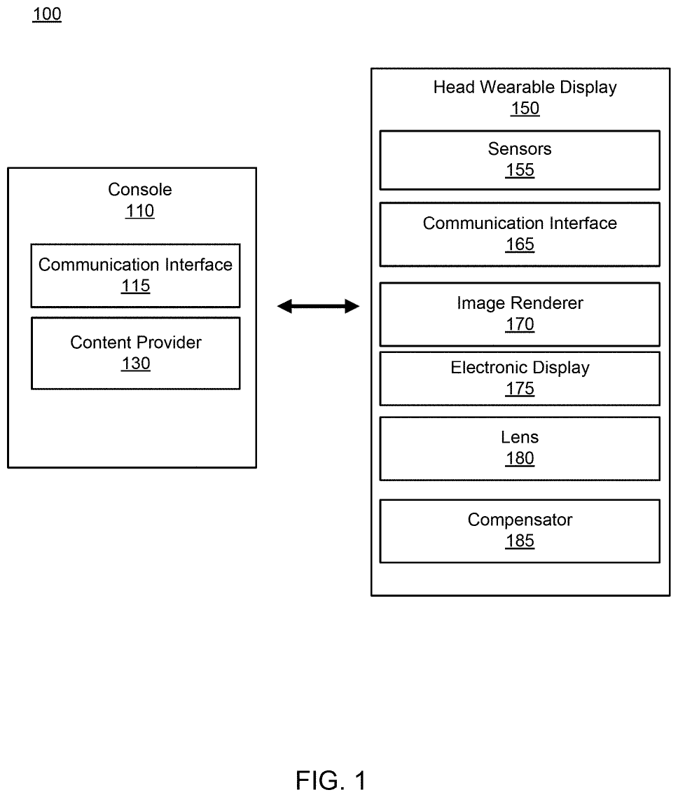

FIG. 1 is a block diagram of an example artificial reality system environment 100. In some embodiments, the artificial reality system environment 100 includes a HWD 150 worn by a user, and a console 110 providing content of artificial reality to the HWD 150. The HWD 150 may be referred to as, include, or be part of a head mounted display (HMD), head mounted device (HMD), head wearable device (HWD), head worn display (HWD) or head worn device (HWD). The HWD 150 may detect its location and/or orientation of the HWD 150 as well as a shape, location, and/or an orientation of the body/hand/face of the user, and provide the detected location/or orientation of the HWD 150 and/or tracking information indicating the shape, location, and/or orientation of the body/hand/face to the console 110. The console 110 may generate image data indicating an image of the artificial reality according to the detected location and/or orientation of the HWD 150, the detected shape, location and/or orientation of the body/hand/face of the user, and/or a user input for the artificial reality, and transmit the image data to the HWD 150 for presentation. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150. For example, some of the functionality of the HWD 150 may be performed by the console 110. In some embodiments, the console 110 is integrated as part of the HWD 150.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the console 110, or both, and presents audio based on the audio information. In some embodiments, the HWD 150 includes sensors 155, a communication interface 165, an image renderer 170, an electronic display 175, a lens 180, and a compensator 185. These components may operate together to detect a location of the HWD 150 and a gaze direction of the user wearing the HWD 150, and render an image of a view within the artificial reality corresponding to the detected location and/or orientation of the HWD 150. In other embodiments, the HWD 150 includes more, fewer, or different components than shown in FIG. 1.

In some embodiments, the sensors 155 include electronic components or a combination of electronic components and software components that detect a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the sensors 155 include eye trackers. The eye trackers may include electronic components or a combination of electronic components and software components that determine a gaze direction of the user of the HWD 150. In some embodiments, the HWD 150, the console 110 or a combination of them may incorporate the gaze direction of the user of the HWD 150 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers incorporate the orientation of the HWD 150 and the relative gaze direction with respect to the HWD 150 to determine a gate direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers may determine that the gaze direction of the user is 20 degrees from the reference direction. In some embodiments, a user of the HWD 150 can configure the HWD 150 (e.g., via user settings) to enable or disable the eye trackers. In some embodiments, a user of the HWD 150 is prompted to enable or disable the eye trackers.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link. Examples of the wireless link can include a cellular communication link, a near field communication link, Wi-Fi, Bluetooth, 60 GHz wireless link, or any communication wireless communication link. Through the communication link, the communication interface 165 may transmit to the console 110 data indicating the determined location and/or orientation of the HWD 150, and/or the determined gaze direction of the user. Moreover, through the communication link, the communication interface 165 may receive from the console 110 image data indicating or corresponding to an image to be rendered and additional data associated with the image.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, image data describing an image of artificial reality to be rendered and additional data associated with the image, and render the image through the electronic display 175. In some embodiments, the image data from the console 110 may be encoded, and the image renderer 170 may decode the image data to render the image. In some embodiments, the image renderer 170 receives, from the console 110 in additional data, object information indicating virtual objects in the artificial reality space and depth information indicating depth (or distances from the HWD 150) of the virtual objects. In one aspect, according to the image of the artificial reality, object information, depth information from the console 110, and/or updated sensor measurements from the sensors 155, the image renderer 170 may perform shading, reprojection, and/or blending to update the image of the artificial reality to correspond to the updated location and/or orientation of the HWD 150. Assuming that a user rotated his head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and a content provider 130. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 150 in a physical space into a virtual space (or simultaneous localization and mapping (SLAM) data), eye tracking data, motion vector information, depth information, edge information, object information, etc. The console 110 may provide the image data and the additional data to the HWD 150 for presentation of the artificial reality. In other embodiments, the console 110 includes more, fewer, or different components than shown in FIG. 1. In some embodiments, the console 110 is integrated as part of the HWD 150.

In some embodiments, the communication interface 115 is an electronic component or a combination of an electronic component and a software component that communicates with the

HWD 150. The communication interface 115 may be a counterpart component to the communication interface 165 to communicate with a communication interface 115 of the console 110 through a communication link (e.g., wireless link). Through the communication link, the communication interface 115 may receive from the HWD 150 data indicating the determined location and/or orientation of the HWD 150, and/or the determined gaze direction of the user. Moreover, through the communication link, the communication interface 115 may transmit to the HWD 150 image data describing an image to be rendered and additional data associated with the image of the artificial reality.

The content provider 130 can include or correspond to a component that generates content to be rendered according to the location and/or orientation of the HWD 150. In some embodiments, the content provider 130 may incorporate the gaze direction of the user of the HWD 150. In one aspect, the content provider 130 determines a view of the artificial reality according to the location and/or orientation of the HWD 150. For example, the content provider 130 maps the location of the HWD 150 in a physical space to a location within an artificial reality space, and determines a view of the artificial reality space along a direction corresponding to the mapped orientation from the mapped location in the artificial reality space. The content provider 130 may generate image data describing an image of the determined view of the artificial reality space, and transmit the image data to the HWD 150 through the communication interface 115. In some embodiments, the content provider 130 may generate additional data including motion vector information, depth information, edge information, object information, hand model data, etc., associated with the image, and transmit the additional data together with the image data to the HWD 150 through the communication interface 115. The content provider 130 may encode the image data describing the image, and can transmit the encoded data to the HWD 150. In some embodiments, the content provider 130 generates and provides the image data to the HWD 150 periodically (e.g., every 11 ms).

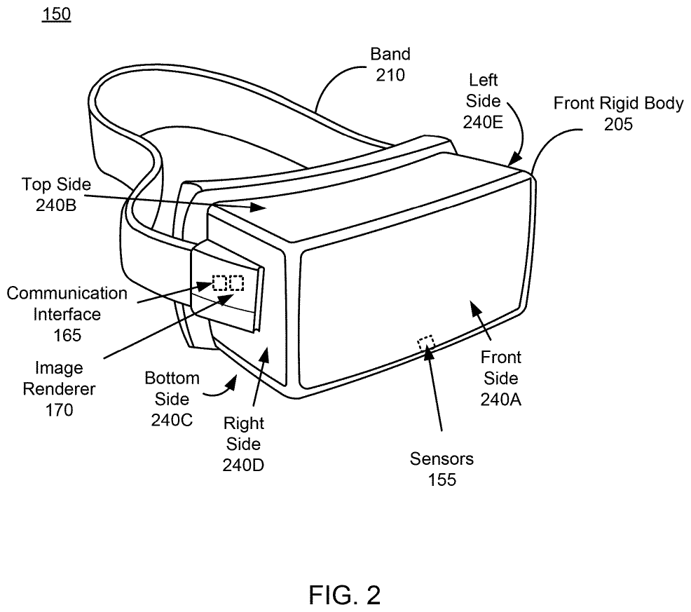

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens 180 (not shown in FIG. 2), the sensors 155, the communication interface 165, and the image renderer 170. In the embodiment shown by FIG. 2, the communication interface 165, the image renderer 170, and the sensors 155 are located within the front rigid body 205, and may not be visible externally. In other embodiments, the HWD 150 has a different configuration than shown in FIG. 2. For example, the communication interface 165, the image renderer 170, and/or the sensors 155 may be in different locations than shown in FIG. 2.

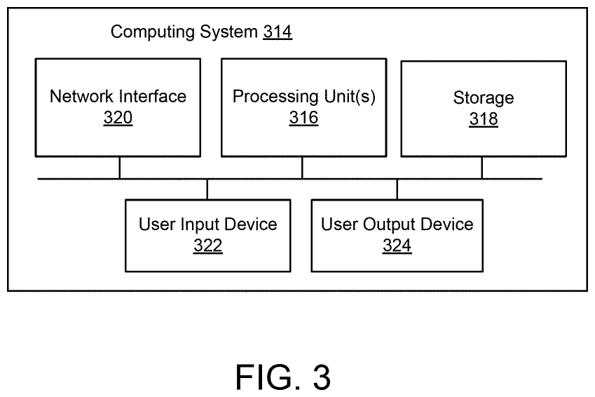

Various operations described herein can be implemented on computer systems. FIG. 3 shows a block diagram of a representative computing system 314 usable to implement the present disclosure. In some embodiments, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

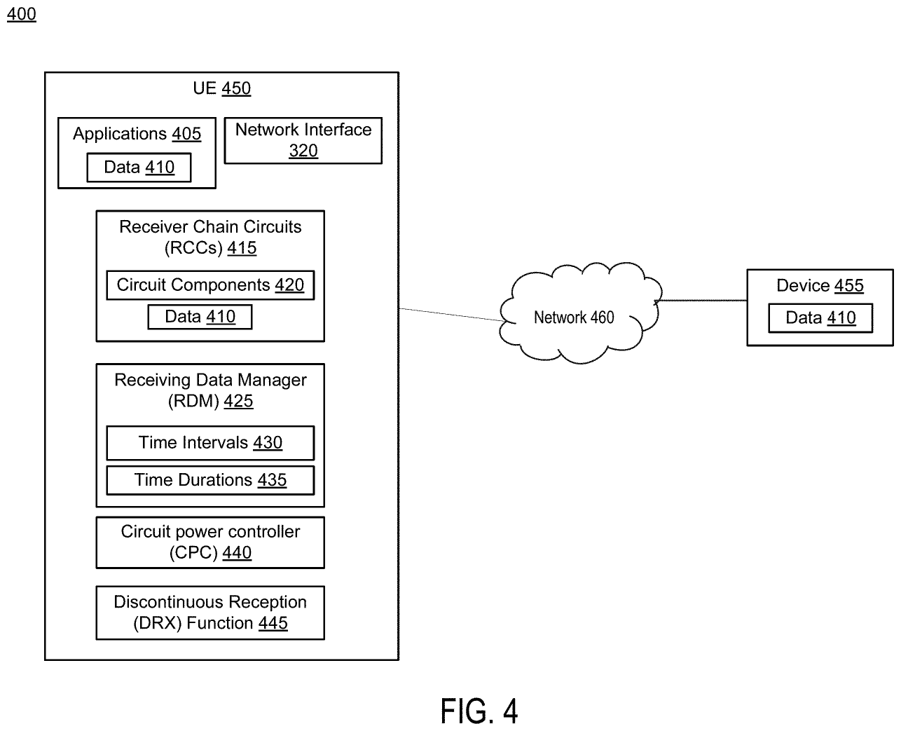

FIG. 4 relates to a system 400 for managing power provided to receiver circuit chains of a user equipment (UE) UE 450 based on determinations (e.g., predictions) on whether or not wireless data is expected to be received by the receiver circuit chains during particular time durations within a chain of periodic time intervals. A UE 450 can include one or more network interfaces 320 and can execute one or more applications 405 that can receive or use data 410. The UE 450 can include one or more receiver chain circuits (RCCs) 415, one or more receiving data managers (RDM) 425, circuit power controllers (CPC) 440 and/or discontinuous reception (DRX) functions 445. Each RCC 415 can include one or more circuit components 420 for processing incoming data 410. Each RDM 425 can monitor and determine time intervals 430 and time durations 435 to determine incoming data time pattern. The UE 450 can communicate with a remote network device 455 over a network 460 and can receive the data 410 from the device 455, via the network 460.

At a high level, an example system 400 improves the energy efficiency of a UE 450 by determining the likelihood that incoming wireless data 410 is to be received within particular time durations 435 of periodic time intervals 430 and reducing power (e.g., shutting down, or reducing the power level of) the RCCs 415 that are expected to receive no data 410 during these time durations 435 while continuing to power RCCs 415 (e.g., at active state power levels) that are expected to process the incoming wireless data 410 the same time durations 435. A UE 450 can utilize a network interface 320 to communicate with, and can receive from, a network device 455 data 410 via a network 460. UE 450 can use/include a computing system 314 (e.g., processing units 316 from FIG. 3) to execute applications 405 receiving data 410. The data 410 can be received first by one or more receiver chain circuits 415, each one including any number of internal circuit components 420 (e.g., antennas, signal filters, mixers, multiplexers, amplifiers and more), which can be used to process the data 410. RDM 425 can monitor the data 410 and can determine (e.g., predicting or establishing a likelihood) that data 410 is going to arrive within particular time durations 435 of the time intervals 430. The RDM 425 can also determine (e.g., based on the type or nature of the data 410 being received, and/or the communications characteristics/history of associated application(s)) which one or more RCCs 415 of the total set of RCCs 415 are expected to receive the incoming data 410 and which RCCs 415 of the total set are not expected to receive any data 410 within the same time duration(s) 435 of the time intervals 430 (e.g., DRX cycles). CPC 440 can then reduce or turn off the power provided to those RCCs 415 (e.g., circuit components 420 of the specific RCCs 415) that are not expected to receive the incoming data 410 for the time duration 435. CPC 440 can maintain (e.g., not reduce), for the time duration 435, the power provided to those RCCs 415 (or their circuit components 420) that are expected to receive the incoming data 410 within the time durations 435. DRX function 445 can be used to manage DRX cycles (e.g., DRX on/active or off/sleep states), which may be coordinated, correlated or coincide with the power control to the RCCs 415, based on the determinations.

UE 450 can include any device that can communicate and receive data 410 over a network 460. UE 450 can include any combination of hardware and software for sending or receiving data 410, including any wired or wireless data. UE 450 can include a device capable of network communication, such as a console 110, a head wearable display 150, a smartphone, a computer, a laptop, a tablet, or a wearable device, such as a smartwatch. UE 450 can include a computing system 314 (illustrated in FIG. 3) and can utilize the network interface 320, processing units 315, storage 318, input devices 322 and output devices 324.

UE 450 can include any number of RCCs 415 for processing data 410, such as, for example two, four, six, eight, 10, 12, 16, 32 or any other number of RCCs 415 for receiving or sending data. Each RCC 415 can include a chain or a combination of circuit components 420 for data processing. UE 450 can include the capability (e.g., RDM 425) for monitoring data and identifying time intervals 430 (e.g., frames) and time durations 435 (e.g., portion of frames) within the time intervals 430 in which data is being received and time durations 435 (e.g., other portions of frames) within the time intervals 430 in which the data 410 is not being received. UE 450 can utilize RDM 425 to determine the likelihood or probability that data 410 is to be received within a next time duration 435 of an upcoming time interval 430 (e.g., DRX cycle). UE 450 can utilize the RDM 425 to identify (e.g., based on the type of data 410 being expected to arrive) the RCC(s) 415 which are expected to process the incoming data 410. UE 450 can utilize circuit power controller 440 to reduce the power to those circuit components 420 of those RCCs 415 that are not expected to be used and can maintain power provided to those components 420 of those RCCs 415 that are expected to receive and process data 410 within the upcoming time durations 435.

Application 405 can include any application executing on a user device (e.g., UE 450) and receiving or sending data 410. Application 405 can include an application for a console 110 or a head wearable display 150. Application 405 can include an application for a smartphone, computer, laptop, tablet or a smartwatch. Application 405 can include an application running in foreground (e.g., displayed and used by the user), or an application 405 in the background. Application 405 in foreground can be assigned, include or associated with a priority, such as a high priority for active or foreground applications, or a low priority for inactive or background applications. Application 405 can include an AR, VR or an MR application, a video game application, an internet browser, a video streaming application, an email, text or a chat application, a social media application or any other application that can be executed on a UE 450. The state of an application (e.g., whether in the foreground or background), can be used to determine whether certain data is to be received, so that one or more RCCs can be activated during the time the data is expected, to receive the data for the application. For instance, if the application is inactive or in the background, it may not be important/needed to receive the data for the application. As such, corresponding RCC(s) may not have to be activated to receive such data. Conversely, if the application is active or in the foreground, it may be important to receive the data for the application. As such, the UE may activate the corresponding RCC(s) to receive such data.

Data 410 can include any data that can be communicated over a network 460. Data 410 can include any data for an application 405, such as any network traffic, payload data, any video or audio data, streaming data, communication data, control or instruction data, data corresponding to images, sound, or any other data that can be provided to any application 405. Data 410 can include data of a particular priority level or type that can be processed by or executed on a RCC 415. For example, data 410 can include data for a high priority application or an application operating in the foreground of the UE 450, which can be associated with, or processed on, a particular RCC 415 used for processing data 410 of that particular type. Data 410 can include data for a low priority application (e.g., an application operating in the background) that can be associated with or processed on a particular RCC 415 for processing data 410 of that particular type. Data 410 can also include a type that can be associated with particular RCCs 415. For example, data 410 for video streaming application can be processed on one RCC 415, while data 410 for instructions to an application can be processed on another RCC 415.

Receiver chain circuit (RCC) 415 can include any group of circuits for processing data 410. RCC 415 can include any combination of hardware and software for processing data 410. RCC 415 can include any organization, arrangement, formation or design of circuit components 420 that can be arranged in a chain or in a particular arrangement or order to process data 410 in a particular manner. For example, a receiver chain circuit 415 can include a chain of a number of circuit components 420 that can be interconnected to each other, each one addressing a portion of the data processing.

For example, an RCC 415 can include an antenna that can be connected to a low-pass, band-pass or high-pass filter, the output of which can be connected to a low noise amplifier, the output of which can be connected to another signal filter, the output of which can be connected to a signal mixer that receives an oscillator signal. The output of the signal mixer can be connected to a filter, the output of which can be connected to an amplifier, the output of which can be connected to another signal filter or to an analog to digital converter (ADC), and the output of which can be connected to a digital signal processor, a controller or a digital signal processing circuit or a device.

For example, an RCC 415 can include an antenna that can be connected to an RF band select filter, that can be connected to a low noise or a power amplifier, that can be connected to a down-conversion mixer, that can be connected to a baseband amplifier, that can be connected to a baseband and anti-aliasing filter, that can be connected to an ADC. For example, RCC 415 can include an radio frequency (RF) antenna that can be connected to a duplex, that can be connected to an RF filter, that can be connected to an amplifier, that can be connected to a mixer, that can be connected to an IF filter, that can be connected to an IF amplifier and that can lead to a baseband signal or an input.

Each individual RCC 415 can include any number or a combination of any circuit components 420. Circuit components 420 can be designed to be included in an individual RCC 415 or can be shared across multiple RCCs 415. For example, an RCC 415 can share an antenna that can be shared with one or more other RCCs 415. In such instances, the shared components may be not be powered down if the other RCC 415 sharing the antenna is also going to use the antenna during that time. A circuit component 420 can include any type and form of a circuit, device or a component within an RCC 415. For example, circuit components 420 can include any one or more of: a signal filter, signal mixer, a low noise or a power amplifier, an oscillator, an analog to digital converter, a digital to analog converter, a processor or a controller or any other circuit or a device that can be used for implementing a portion of the data processing.

Receiving data manager 425 can include any combination of hardware and software for managing, controlling, predicting or determining timing of the data 410 to be received or circuitry (e.g., RCCs 415 or circuit components 420) to be used for processing the data 410. Receiving data manager can monitor time intervals 430 to determine time durations 435 within the time intervals 430 during which data 410 is received, as well as time durations 435 during which data 410 is not being received. RDM 425 can determine which RCCs 415 are going to receive and process data 410 expected to arrive during particular upcoming time periods 435 of the time intervals. RDM 425 can determine the likelihood or probability that data is going to be received within an upcoming time duration 435 of an upcoming time interval 430 (e.g., upcoming data frame). For example, if data is being received in time intervals 430 corresponding to 15 frames per second, then each time interval 430 can correspond to 1/15 of a second. Time durations 435 within each time interval 430 can correspond to or correlate with DRX cycles (e.g., active/on or sleep/off cycles) of the discontinuous reception.

Time interval 430 can correspond to a frame or time duration within which data can be received. Time interval 430 can include durations that can be defined in terms of frames per second, such as 15 frames/second, which can correspond to 66.66 ms for each time interval 430, or 30 frames/second, which can correspond to 33.33 ms for each time interval 430. Time intervals 430 can be periodic or aperiodic and can include any number of time durations 435. Time interval 430 can include one or more time durations 435 during which data 410 can be received or is expected to be received. Such active time durations 435 can correspond to on-period or active phase of the DRX cycle. Such active time durations 435 can correspond to a portion of the off-period (e.g., sleep) of the DRX cycle that is adjacent to the on-period (e.g., active phase) of the DRX cycle. Time interval 430 can include one or more time durations 435 during which data 410 may not be received or is not expected to be received. Time durations 435 can correspond to time instances during which DRX is at on-duration, while other time durations 435 can correspond to time instances during which DRX is at off-durations (e.g., sleep mode).

RDM 425 can include the functionality to identify, determine or predict the time durations 435 within time intervals 430 during which data 410 is expected to be received (e.g., within a particular likelihood threshold). RDM 425 can include the functionality to determine or predict the RCCs 415 which are to process the data 410 to be received within the particular time durations 435. RDM 425 can monitor the data 410 and can determine, based on type or characteristic of the data, which of the RCCs 415 are to process the data 410. RDM 425 can include the functionality to determine or predict the time durations 435 during which data 410 for a particular application 405 is expected to or not expected to be received. RDM 425 can include the functionality to determine or predict the RCCs 415 which are not going to be used during an upcoming time duration 435 during which data 410 is expected to be received.

RDM 425 can include the functionality to monitor or observe data 410 being received over time to define or determine time intervals 430 and time durations 435. RDM 425 can determine the intervals 430 and/or time durations 435 both with respect to those during which data 410 is expected to be received and those during which data 410 is not expected to be received. RDM 425 can determine the likelihood for the data to be received during any time duration 425 or a time interval. For example, a RDM 425 can determine that there is greater than 80% chance or likelihood that data 410 is to be received at a particular RCC 415 during a particular time duration 435. Likewise, RDM 425 can determine that there is greater than 80% chance or likelihood that data 410 is not to be received at a particular RCC 415 during a particular time duration 435.

Circuit power controller (CPC) 440 can include any combination of hardware and software for controlling power supplied or provided to any RCCs 415 or circuit components 420 of any RCCs 415, or for controlling the operational state (e.g., low power or sleep or inactive or off state, normal power or wake or active or on state) of such RCCs 415 or circuit components 420. CPC 440 can include circuitry, controllers, processors or instructions for controlling power output to any of the circuit components 420 of any RCCs 415. CPC 440 can include the functionality for turning on or off the power to an entire RCC 415 or any combination of circuit components 420 of any RCC 415. CPC 440 can reduce or regulate the power output to any particular circuit component 420 of any RCC 415. For example, if an RCC 415 is having its power reduced, the CPC 440 can reduce the power to a particular subset of circuit components 420 that are not shared with other RCCs 415 that are being actively used (e.g., are expected to receive data).

Discontinuous reception (DRX) function 445 can include any combination of hardware and software for implementing DRX for received or sent data 410. DRX function 415 can include the functionality for identifying a DRX off-period within a time interval 430, during which at least a portion of the UE 450 (e.g., one or more RCCs 415) can be asleep. DRX function 415 can include the functionality for an DRX on-period within a time interval 430, during which at least a portion of UE 450 (e.g., one or more RCCs 415) can be powered and operating.

Network 460 can include any network over which data 410 can be transferred or transmitted. Network 460 can include a wireless network, a wired network, or a combination of wireless and wired network. Network 460 can include any number of network devices (e.g., devices 455) for forwarding data from one network device to the UE 450 and vice versa. Network 460 can include any one or more of a local area network (LAN), a wide area network (WAN), a cellular network, a Bluetooth network, a Wi-Fi or wireless LAN (WLAN) network or any other network over which data 410 can be received.

Device 455 can include any network device that can communicate over a network 460. Device 455 can include a server (e.g., an application or a web server), a server farm, a cloud-based function or a service. Device 455 can include a UE 450 or any other device, such as a proxy server or a proxy gateway device. Device 455 can include a router (e.g., a Wi-Fi router) a Bluetooth device or a cellular network base station or a tower. Device 455 can include data 410 and can transmit data 410, over the network 460, to the UE 450.

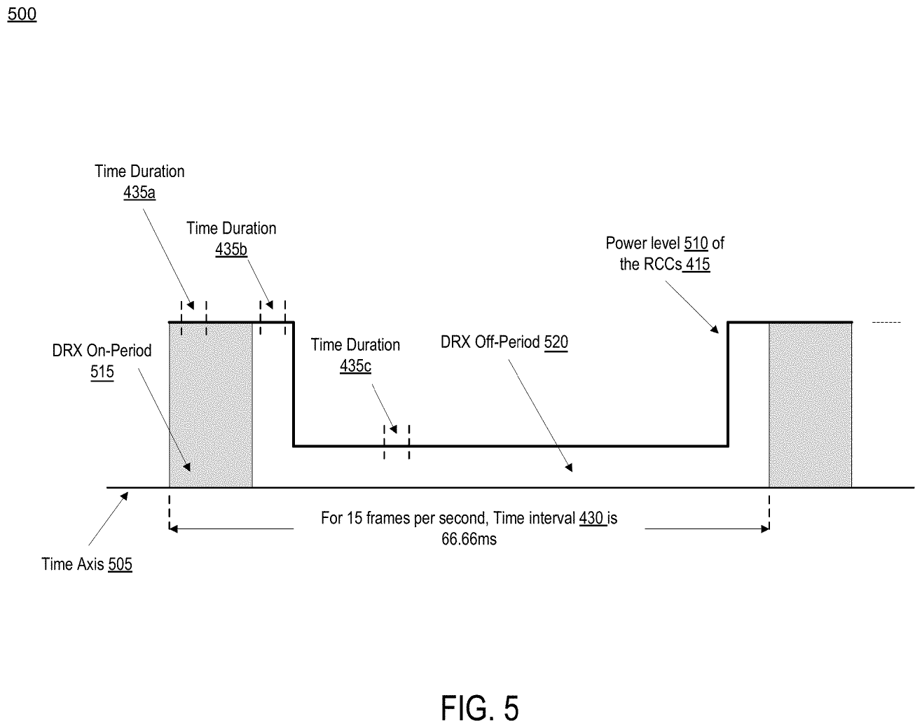

FIG. 5 depicts an example of a plot 500 of a power level 510 provided to the plurality (e.g., the totality) of the RCC 415 of an UE 450 as a function of a time. Plot 500 shows a time interval 430 that is plotted on a time axis 505 and that includes or coincides with a DRX cycle of the RCCs 415, including an DRX on-period 515 (e.g., active phase) and an DRX off-period 520 (e.g., sleep phase). Plot 500 shows the time interval 430 including time durations 435a, 435b and 435c as they correspond to the DRX on or off periods. The power level 510 of the RCCs 415 over a time interval 430 can vary during different portions of the time interval 430 since the power provided to (e.g., consumed by) RCCs 415 can be reduced to some of the RCCs 415 based on the expectations of the data 410 to be received by some of the RCCs 415 and not others, during such time durations 435. Time interval 430 can correspond to frame configuration that can include, for example, 15 frames per second in which a time interval 430 can correspond to 66.66 ms.

A first portion of the time interval 430 can correspond to a DRX on-period 515 during which all RCCs 415 of the UE 450 can be active and fully powered. The power level 510 can be high during the DRX on-period 515, which can also include, correspond to, or coincide with, the time period 435a. The system 400 can determine (e.g., predict) that the data 410 is likely to be received for one or more RCCs 415 during the time duration 435a and so the power level 510 to the RCCs 415 can remain high. Likewise, system 400 can determine (e.g., predict) that during the time duration 435b there is also a high likelihood that the data 410 is to be received, even though time duration 435b corresponds to or coincides with a DRX off-period 520 (e.g., sleep phase). However, time duration 435b can correspond to a time duration 435 that is adjacent/proximate to the DRX on-period 515 and so there can still be a high likelihood that data 410 is to be received during the time period 435b. In some embodiments, the power level 510 can fully align with DRX on-period 415 and DRX off-period 520 (e.g., power level 510 line can line up with the on and off periods 515 and 520). In some embodiments, the power level 510 can remain high (e.g., include an active portion within a part of the DRX off-period 520 that is adjacent to the DRX on-period 515. This can be done due to the possibility that network jitter and delays can cause some of the data to arrive outside of the DRX on-period 515. Time duration 435c can correspond to the portion of the time interval 430 during a DRX off-period 520 (e.g., sleep) during which the system 400 can determine that the data is not going to be received. The power level 510 during the time duration 435c can be lower than during the time durations 435a and 435b. DRX cycle can be periodic and can conform to the time interval 430, while the power level of the RCCs 415 can include high power level 510 portions that include DRX on-periods 515 and their corresponding adjacent time durations 435 (e.g., surrounding the on-periods 515) and low power level 510 portions that are within off-periods 520 and not adjacent to on-periods 515.

DRX cycle or on/off periods (of one or more of the RCCs) may or may not be mapped to the connected mode DRX (C-DRX) cycle or on/off-periods that can be configured by the network 460 (e.g., 4G or 5G cellular communication devices communicating with the UE 450 via the network 460). In some embodiments, certain on or off periods of a C-DRX can be one-to-one mapped to DRX cycle (e.g., DRX on period 515 or DRX off period 520) of the UE 450. Sometimes, the on or off periods of the C-DRX can be offset from the on or off periods (e.g., 515 or 520) of the DRX cycle of the UE 450. The offset between the DRX and C-DRX cycles (e.g., on and off periods) can be such that the on periods 515 and/or off periods 520 of the DRX and the C-DRX, fully overlap, partially overlap and partially do not overlap, or that they do not overlap at all (e.g., they are off phase with respect to each other).

The DRX cycle of one or more of the RCCs (e.g., DRX on/off periods) can be determined based on traffic behavior. For example, DRX function 445 can establish the DRX cycle (e.g., on and off periods of the DRX cycle) based on the traffic behavior of an application 405 (corresponding to the one or more of the RCCs) operating on the UE 450. The application 405 can be an application operating in the foreground of the UE 450, or an application that is assigned a high priority with respect to other applications 405.

DRX function 445 can determine the DRX on/off periods (of one or more of the RCCs) based on C-DRX configuration from the network 460 or in the absence of any C-DRX configuration from network. For example, DRX function 445 can determine the on periods 515 or off periods 520 of the DRX cycle based on the C-DRX signal/configuration from a device (e.g., device 455) on the network 460. For example, DRX function 445 can determine the on periods 515 or off periods 520 of the DRX cycle in absence (or independent) of any C-DRX signal/configuration. For example, DRX function 445 can determine on/off periods of the DRX on the UE 450 based on the timing of the incoming network traffic with respect to time durations 435 and/or time intervals 430.

In one example, the present disclosure relates to a UE 450 that is a wireless communication device (e.g., a heads up display, a smartphone or a tablet). The UE 450 can include one or more processors (e.g., processing units 316) that can be configured (e.g., have or execute instructions) to identify any number of RCCs 415 for processing data 410 to be received by the wireless communication device (e.g., UE 450) from a wireless network 460. Data 410 can include data for an application 405 executing on a UE 450. The one or more processors (e.g., processing units 316) can be configured to determine (e.g., predict or estimate) that there is a likelihood (e.g., above a threshold level) that a specific application and/or a first RCC 415 of the plurality of RCCs 415 is to receive the data 410 within a time duration 435 and that another application and/or a second RCC 415 of the plurality of RCCs 415 is to receive no data 410 within the time duration 435. The time duration 435 can include a temporal portion of a time interval 430 (e.g., a frame of transmitted data). The one or more processors (e.g., processing units 316) can be configured to cause power to be reduced to the second RCC 415 and not be reduced to the first RCC 415, within the first time duration 435, responsive to the determination. For example, the RDM 425 can identify the RCCs 415 used to process data 410 determined or predicted to be received during the time duration 435 and can identify RCCs 415 not to be used to process any incoming data 410, and may then reduce the power to those RCCs 415 (or their corresponding circuit components 420) that are not processing data 410 during the time duration 435.

The time duration 435 can be within, or corresponding to (e.g., temporally align with) an off period (e.g., sleep phase) of a discontinuous reception (DRX) cycle of the plurality of RCCs 415 of the wireless communication device. The one or more processors (e.g., processing units 315) can be configured to cause the power to not be reduced to the first RCC 415 and the second RCC 415 within an on period (e.g., active phase) of a discontinuous reception (DRX) cycle. The one or more processors can be configured to determine that the first RCC 415 and the second RCC 415 are each to have a likelihood (e.g., at least above a defined threshold) of receiving the data 410 within another time duration 435 (e.g., 435b) during an off period (e.g., sleep phase) of a discontinuous reception (DRX) cycle. The one or more processors can be configured to, responsive to the determination that the first RCC 415 and the second RCC 415 are each to have a likelihood (e.g., at least above a defined threshold) of receiving the data 410 within the another time duration 435b, cause the power to not be reduced to the first RCC 415 and the second RCC 415 within the another time duration 435b. Accordingly, RCCs 415 can be fully powered and operational during at least a portion of the off-period DRX cycle.

The one or more processors can be configured to determine that the first RCC 415 and the second RCC 415 are each to have at least a defined likelihood (e.g., a probability that is at least above a threshold level) of receiving the data 410 within the time duration 435 and that the second RCC 415 is to receive no data within the time duration. This determination can be made by determining that a first application 405 or function associated with the first RCC 415 is expected to receive the data 410 within the time duration 435 and that a second application 405 or function associated with the second RCC 415 is expected to receive no data 410 within the time duration 435. The first application 405 can be an active application 405, or operating in the foreground, while the second application 405 can be an inactive application or operating in the background. The first or second functions can belong the same or a different application 405.

Each of the plurality of RCCs 415 can include any number of component circuits 420, such as at least one or more of: a multiplexer, a filter, a mixer, an amplifier, or an analog to digital converter. RCCs 415 can share some of the components, such as antennas or oscillators. When RCCs 415 have their power managed (e.g., shut off or reduced), the CPC 440 can manage the power of the component circuits 420 that are not shared with RCCs 415 that are going to be operational during the same time period 435 when one or more RCCs 415 are being shut down or have their power reduced.

The one or more processors can be configured to cause the power to be reduced to the second RCC 415 by causing at least one of the components 420 (e.g., a multiplexer, a filter, a mixer, an amplifier or an analog to digital converter) of the second RCC 415 to be disconnected or gated from the power. Additionally or alternatively, one or more circuit components 420 can have their power (e.g., voltage and/or current) reduced, but not turned off entirely.

The one or more processors can be configured to determine that a third RCC 415 of the plurality of RCCs 415 is to receive no data within the time duration. Responsive to the determination that the third RCC 415 is to receive no data 410 within the time duration 435, the one or more processors can be configured to cause power to be reduced to the third RCC 415 within the first time duration. The first time duration can be within (or corresponding to, or temporally aligning with) an off period of a discontinuous reception (DRX) cycle.

The one or more processors can be configured to determine that an application 405 associated with the first RCC 415 received prior data 410 within a portion of a preceding time interval 430 that corresponds to the time duration 435. The one or more processors can predict, responsive to the application 405 receiving the prior data within the portion that the first RCC 415 is to receive the data 410 within the time duration 435. Some RCCs 415 can be associated with or correspond to particular types of data 410, such as streaming data, video or audio data. Such RCCs 415 can be assigned to the data 410 being received in response to the characteristic of the data 410 being recognized by the RDM 425 recognizing the type of data 410 being received.

The one or more processors are configured to determine that an application 405 associated with the second RCC 415 did not receive prior data 410 within a portion of a preceding time interval 430 that corresponds to the time duration 435. The one or more processors can be configured to predict (e.g., determine or estimate), responsive to the application not receiving the prior data 410 within the portion of the preceding time interval 430 (e.g., time duration 435), that the second RCC 415 is to receive no data 410 (or, in some cases, not required to receive data, e.g., for a background application) within the time duration 435.

In some aspects, the present solution relates to a non-transitory computer readable medium storing program instructions. The instructions can cause at least one processor of a UE 450 identify a plurality of RCCs 415 for processing data to be received by the wireless communication device from a wireless network. The one or more processors can determine that a first RCC 415 of the plurality of RCCs 415 is to receive the data 410 within a time duration 435 and that a second RCC 415 of the plurality of RCCs 415 is to receive no data 410 within the time duration 435. The determination or prediction can be made according to the data 410 or traffic corresponding to the application 405, and/or the state/priority of the application 405. The instructions can cause at least one processor to, responsive to the determination, cause power to be reduced to the second RCC 415 and not be reduced to the first RCC 415, within the first time duration 435. The time duration 435 can be within an off period 520 of a discontinuous reception (DRX) cycle of the plurality of RCCs 415 of the UE 450. The instructions can cause the at least one processor to cause the power to not be reduced to the first RCC 415 and the second RCC 415 within an on period 515 of the DRX cycle.

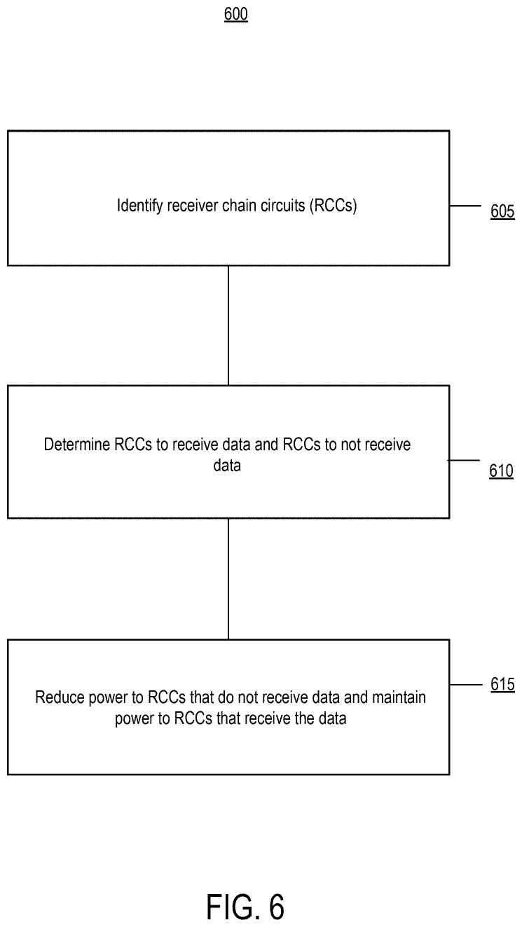

FIG. 6 illustrates an example flowchart of a method 600 of managing power to receiver chain circuits based on determinations (e.g., predictions) of whether or not data is to be expected to be received (and/or is required to be received, e.g., for an application) during particular upcoming time periods. Method 600 can include ACTS 605-625. The method 600 can be performed, for example, by one or more features of the system 400, including the features or examples illustrated or discussed in connection with FIGS. 1-4. At ACT 605, the method identifies receiver chain circuits (RCCs). At ACT 610, the method determines the RCCs to receive data and those RCCs to not receive data. At ACT 615, the method reduces power to RCCs that do not receive data and maintain power to RCCs that receive the data.

At ACT 605, the method identifies receiver chain circuits (RCCs). The user equipment (e.g., wireless communication device) can identify a plurality of RCCs for processing data to be received by the wireless communication device from a wireless network. For example, the UE can identify a set of RCCs for receiving wireless data. Some of the RCCs can be associated with or configured to process a particular type of data (e.g., video data, stream data, AR/VR data, or control data) for any number of applications executing on the wireless communication device.

Each of the plurality of RCCs can include any number of circuit components. Circuit components of each of the RCCs can be arranged, configured or organized so as to process a particular type of data in a particular way. For example, some RCCs can be configured to process video data, some RCCs can be configured to process streaming data, some RCCs can be configured to process AR/VR data, while other RCCs can be configured to process background application data (e.g., instructions, controls or feedback messages).

The wireless communication device can identify the circuit components in each of the RCCs. Circuit components can include any one or more of: a multiplexer, a signal filter (e.g., high pass, low pass, band pass or anti-aliasing filter), a mixer (for mixing two or more signals), an amplifier (e.g., a low noise amplifier or a power amplifier), or an analog to digital converter or a digital to analog converter. The wireless communication device can include a processor or a controller for processing data.

At ACT 610, the method determines that a first RCC is to receive data. The UE (e.g., the wireless communication device) can determine that a first RCC of the plurality of RCCs is to receive the data (e.g., for a specific application) within a time duration. The UE can determine that a second RCC of the plurality of RCCs is to receive no data within the same time duration (e.g., for a certain application). The UE can identify or determine all of the RCCs that are expected to receive incoming wireless data during an upcoming time duration and all of the RCCs that are expected not to receive incoming wireless data during the same upcoming time duration. The UE can make this determination based on prior time interval observations in which data has been received within one or more time durations of the time interval and not received within other time durations of the time interval. The UE can make this determination with respect to all of incoming wireless data, or according to (or based on) the data of a particular application. For example, a receiving data manager can determine that a particular data of a particular application is to receive within a particular upcoming time duration based on observing that in prior time intervals the same application has received the data during the same time duration in the upcoming time interval.

In some implementations, the time duration is within an off period of a discontinuous reception (DRX) cycle of the plurality of receiver chain circuits of the wireless communication device. The UE (e.g., the wireless communication device) can determine that the first RCC and the second RCC are each to have a defined likelihood (e.g., a likelihood/probability above a defined threshold) of receiving the data (e.g., data for a particular application) within another time duration during an off period of a discontinuous reception (DRX) cycle. The wireless communication device can determine that the first receiver chain circuit and the second receiver chain circuit are each to have at least a defined likelihood of receiving the data within the time duration, and for instance should be active to receive such data (e.g., for a first application, or for a first function of the first application, associated with a certain priority/state). This determination can be made by determining that a first application or function associated with the first RCC is expected to receive the data within the time duration, and that a second application or function associated with the second RCC is expected to receive no data within the time duration. The first and second functions can be functions of the same application. For example, the two functions can correspond to two different types of data of the same function and can be processed by two different RCCs.

The wireless communication device can determine that a third receiver chain circuit of the plurality of receiver chain circuits is to receive no data within the time duration (e.g., either that no data is expected to arrive, or that the data is not required to be received/processed). The wireless communication device can determine that an application associated with the first receiver chain circuit received prior data within a portion of a preceding time interval that corresponds to the time duration. The wireless communication device can predict, responsive to the application receiving the prior data within the portion, that the first receiver chain circuit is to receive the data within the time instance.

For example, the application can include an application operating in the foreground or having a high priority, while other applications can operate in the background or have low priority. The wireless communication device can determine the RCCs to receive the data in the upcoming time duration of an upcoming time interval (e.g., frame) in response to the application being recognized as a high priority (or foreground) application.

The wireless communication device can determine that an application associated with the second receiver chain circuit did not receive prior data within a portion of a preceding time interval that corresponds to the time duration. The wireless communication device can predict, responsive to the application not receiving the prior data within the portion, that the second receiver chain circuit is to receive no data within the time duration.

At ACT 615, the method reduces power to RCCs that do not receive data and can maintain/supply (normal active state) power to RCCs that receive the data. The wireless communication device can, responsive to the determination in ACT 610, cause power to be reduced to the second RCC (not expected to process data) and not be reduced to the first RCC (expected to process data) within the first time duration. The wireless communication device can cause the power to not be reduced to the first receiver chain circuit and the second receiver chain circuit within an on period of a discontinuous reception (DRX) cycle. Responsive to the determination that the first RCC and the second RCC are each to have a likelihood (above a defined threshold) of receiving the data within the another time duration, the wireless communication device can cause the power to not be reduced to the first RCC and the second RCC within the another time duration.

The wireless communication device can utilize a circuit power controller to reduce or disconnect power to the one or more circuit components of the RCC. For example, a processor can execute or send commands to cause the power to be reduced to disconnected to one or more circuit components of the RCCs that are determined or predicted not to receive data during upcoming time duration. For example, a circuit power controller can utilize gates or logic structures to reduce, bar or stop the power from being provided to all the RCCs that are predicted to not process data during the time duration. The power can be reduced or disconnected from the RCCs or the circuit components of the RCCs for the entire or a part of the time duration.

The wireless communication device can cause the power to be reduced to the second RCC by causing at least one component circuit of the second RCC to be disconnected or gated from the power. For example, the wireless communication device can disconnect or gate from power (or reduce power to) any one or more of: a multiplexer, a filter, a mixer, an amplifier or an analog to digital converter of the second RCC. For example, the wireless communication device can cause the power to be reduced or disconnected from one or more circuit components of an RCC that are not shared with other RCCs being used. The wireless communication device can maintain power to the circuit components that are shared with the RCCs that are going to be used within the time duration in which data is expected to be received.

The wireless communication device can cause power to be reduced to the third RCC within the first time duration in response to the determination that the third RCC is to receive no data within the time duration. The first time duration can be within an off period of a discontinuous reception (DRX) cycle or within an on period of the DRX cycle. The first time duration can be within an off period of the DRX cycle that is adjacent to the on-period of the DRX cycle.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
identifying, by a wireless communication device, a plurality of receiver chain circuits for processing data to be received by the wireless communication device from a wireless network;
determining, by the wireless communication device, that a first receiver chain circuit of the plurality of receiver chain circuits is to receive the data within a time duration and that a second receiver chain circuit of the plurality of receiver chain circuits is to receive no data within the time duration; and
causing, by the wireless communication device responsive to the determination, power to be reduced to the second receiver chain circuit and not be reduced to the first receiver chain circuit, within the time duration.

2. The method of claim 1, wherein the time duration is within an off period of a discontinuous reception (DRX) cycle of the plurality of receiver chain circuits of the wireless communication device and comprising:
causing, by the wireless communication device, the power to not be reduced to the first receiver chain circuit and the second receiver chain circuit within an on period of a discontinuous reception (DRX) cycle.

3. The method of claim 1, comprising:
determining, by the wireless communication device, that the first receiver chain circuit and the second receiver chain circuit are each to have at least a defined likelihood of receiving the data within another time duration during an off period of a discontinuous reception (DRX) cycle; and
responsive to the determination that the first receiver chain circuit and the second receiver chain circuit are each to have at least a defined likelihood of receiving the data within the another time duration, cause the power to not be reduced to the first receiver chain circuit and the second receiver chain circuit within the another time duration.

4. The method of claim 1, comprising:
determining, by the wireless communication device, that the first receiver chain circuit and the second receiver chain circuit are each to have at least a defined likelihood of receiving the data within the time duration, by:
determining, by the wireless communication device, that a first application or function associated with the first receiver chain circuit is expected to receive the data within the time duration, and that a second application or function associated with the second receiver chain circuit is expected to receive no data within the time duration.

5. The method of claim 1, wherein each of the plurality of receiver chain circuits includes at least one of: a multiplexer, a filter, a mixer, an amplifier, or an analog to digital converter.

6. The method of claim 1, comprising:
causing, by the wireless communication device, the power to be reduced to the second receiver chain circuit by causing at least one of a multiplexer, a filter, a mixer, an amplifier or an analog to digital converter of the second receiver chain circuit to be disconnected or gated from the power.

7. The method of claim 1, comprising:
determining, by the wireless communication device, that a third receiver chain circuit of the plurality of receiver chain circuits is to receive no data within the time duration; and
causing, by the wireless communication device responsive to the determination that the third receiver chain circuit is to receive no data within the time duration, power to be reduced to the third receiver chain circuit within the first time duration, the first time duration within an off period of a discontinuous reception (DRX) cycle.

8. The method of claim 1, comprising:
determining, by the wireless communication device, that an application associated with the first receiver chain circuit received prior data within a portion of a preceding time interval that corresponds to the time duration; and
predicting, by the wireless communication device, responsive to the application receiving the prior data within the portion, that the first receiver chain circuit is to receive the data within the time instance.

9. The method of claim 1, comprising:
determining, by the wireless communication device, that an application associated with the second receiver chain circuit did not receive prior data within a portion of a preceding time interval that corresponds to the time duration; and
predicting, by the wireless communication device responsive to the application not receiving the prior data within the portion, that the second receiver chain circuit is to receive no data within the time duration.

10. A wireless communication device comprising:
one or more processors configured to:
identify a plurality of receiver chain circuits for processing data to be received by the wireless communication device from a wireless network;
determine that a first receiver chain circuit of the plurality of receiver chain circuits is to receive the data within a time duration and that a second receiver chain circuit of the plurality of receiver chain circuits is to receive no data within the time duration; and
responsive to the determination, cause power to be reduced to the second receiver chain circuit and not be reduced to the first receiver chain circuit, within the time duration.

11. The wireless communication device of claim 10, wherein the time duration is within an off period of a discontinuous reception (DRX) cycle of the plurality of receiver chain circuits of the wireless communication device.

12. The wireless communication device of claim 10, wherein the one or more processors are configured to:
cause the power to not be reduced to the first receiver chain circuit and the second receiver chain circuit within an on period of a discontinuous reception (DRX) cycle.

13. The wireless communication device of claim 10, wherein the one or more processors are configured to:
determine that the first receiver chain circuit and the second receiver chain circuit are each to have at least a defined likelihood of receiving the data within another time duration during an off period of a discontinuous reception (DRX) cycle; and
responsive to the determination that the first receiver chain circuit and the second receiver chain circuit are each to have at least a defined likelihood of receiving the data within the another time duration, cause the power to not be reduced to the first receiver chain circuit and the second receiver chain circuit within the another time duration.

14. The wireless communication device of claim 10, wherein the one or more processors are configured to:
determine that the first receiver chain circuit and the second receiver chain circuit are each to have at least a defined likelihood of receiving the data within the time duration and that the second receiver chain circuit is to receive no data within the time duration, by:
determining that a first application or function associated with the first receiver chain circuit is expected to receive the data within the time duration, and that a second application or function associated with the second receiver chain circuit is expected to receive no data within the time duration.

15. The wireless communication device of claim 10, wherein each of the plurality of receiver chain circuits includes at least one of: a multiplexer, a filter, a mixer, an amplifier, or an analog to digital converter.

16. The wireless communication device of claim 10, wherein the one or more processors are configured to:
cause the power to be reduced to the second receiver chain circuit by causing at least one of a multiplexer, a filter, a mixer, an amplifier or an analog to digital converter of the second receiver chain circuit to be disconnected or gated from the power.

17. The wireless communication device of claim 10, wherein the one or more processors are configured to:
determine that a third receiver chain circuit of the plurality of receiver chain circuits is to receive no data within the time duration; and
responsive to the determination that the third receiver chain circuit is to receive no data within the time duration, cause power to be reduced to the third receiver chain circuit within the first time duration, the first time duration within an off period of a discontinuous reception (DRX) cycle.

18. The wireless communication device of claim 10, wherein the one or more processors are configured to:
determine that an application associated with the first receiver chain circuit received prior data within a portion of a preceding time interval that corresponds to the time duration; and
predict, responsive to the application receiving the prior data within the portion, that the first receiver chain circuit is to receive the data within the time duration.

19. The wireless communication device of claim 10, wherein the one or more processors are configured to:
determine that an application associated with the second receiver chain circuit did not receive prior data within a portion of a preceding time interval that corresponds to the time duration; and
predict, responsive to the application not receiving the prior data within the portion, that the second receiver chain circuit is to receive no data within the time duration.

20. A non-transitory computer readable medium storing program instructions for causing at least one processor of a wireless communication device to:
identify a plurality of receiver chain circuits for processing data to be received by the wireless communication device from a wireless network;
determine that a first receiver chain circuit of the plurality of receiver chain circuits is to receive the data within a time duration and that a second receiver chain circuit of the plurality of receiver chain circuits is to receive no data within the time duration;
responsive to the determination, cause power to be reduced to the second receiver chain circuit and not be reduced to the first receiver chain circuit, within the time duration, wherein the time duration is within an off period of a discontinuous reception (DRX) cycle of the plurality of receiver chain circuits of the wireless communication device; and
cause the power to not be reduced to the first receiver chain circuit and the second receiver chain circuit within an on period of the DRX cycle.
